(19) United States
(12) Patent Application Publication
(10) Pub. No.: US 2007/0081320 A1
(43) Pub. Date: Apr. 12, 2007

(54) Electroluminescent illumination for audio components

(76) Inventor: Mark Gilbert, Tuscaloosa, AL (US)

Correspondence Address: MCHALE & SLAVIN, P.A., 2855 PGA BLVD, PALM BEACH GARDENS, FL, 33410, US

(21) Appl. No.: 11/200,855

(22) Filed: Aug. 8, 2005

(51) Int. Cl. F21K 2/00

(52) U.S. Cl. 362/34

(57) ABSTRACT

The present invention is an electroluminescent panel which is used in conjunction with electrical components to provide illumination for the components. The invention comprises an electroluminescent panel which is powered by a power supply located within an electrical component. The power supply includes an electrical voltage inverter and a power source. The electroluminescent panel is positioned on top of the electrical component. A mesh grill and/or cover could be positioned on top of the panel. Mean are provided for the rapid interchange of the panels without the need for tools.

### FIELD OF THE INVENTION

This invention relates generally to lighting systems for audio and video components. More specifically, the present invention relates to a lighting system which illuminates a component of an audio or video system to enhance its aesthetic appeal to consumers. The lighting system can be incorporated into the component during manufacture or added as an after market accessory.

### BACKGROUND OF THE INVENTION

Electroluminescent Technology works via the direct conversion of electrical energy into light without the production of thermal energy. As opposed to inefficient incandescent methods of light production that utilize electrical resistance to produce heat, then utilize heat to liberate photons of light from a filament, electroluminescent technology provides an efficient single stage conversion from electricity to light. Various devices use electroluminescence, as the scientific meaning of the term describes a broad category comprising any such devices that convert electrical energy directly to photons. In industry however, the term electroluminescent typically refers to three popular categories of EL products; active matrix EL displays such as flat monitors made with EL phosphor; flat solid colored EL films (also known as panels, foils, back light membranes, etc.); and printed EL displays that use EL ink to print detailed lines, graphs, pictures or other stationary graphics on a flexible printable plastic film that can be energized to illuminate the graphics printed thereon.

In practice, electrons increase the energy level of an electroluminescent material forcing the material to liberate photons of light upon return to its de-energized ground state. Likewise, physical and electrical properties of electroluminescent lighting systems are directly related to the electrical and physical properties of the materials that comprise the system. Consequently, any improvements in materials, films, deposition methods or EL chemistry directly and instantly cause improvements in EL lighting technology and its applications.

Electroluminescent (EL) illumination products have early roots in both space program and consumer applications. Early, highly successful applications of EL displays included early automotive dashboard displays that were pioneered in the mid to late 1950's by Chrysler automotive and subsequently included as standard features in many cars by 1960. Electroluminescent dashboard clusters were standard features in models like the 1960-1962 Chrysler, 1960-1963 Imperial and 1966-1967 Dodge Charger. Similar illumination systems were used as monitors aboard the Apollo spacecraft as an electroluminescent visual bar-graph system to allow astronauts to monitor the status of the main flight management systems computer. Such early EL illumination systems of the 1960s utilized a steel backplane conductor with a layer of electroluminescent ceramic deposited thereon. A transparent conductor was positioned in front of the ceramic layer, and then the entire “sandwich” was coated with a protective glass or protective chemical layer to limit oxidation and increase physical durability while providing electrical insulation. Separate electrical connections were attached to the conductive backplane and the transparent conductor covering the face of the phosphor ceramic material, allowing a connection to an external power source. Early electrical power sources for EL displays were typically DC to AC inverters, similar to those that power EL systems today. However, early inverters were bulkier and less efficient than micro-inverters presently available.

As quality of materials dictates the overall visual appeal, color, luminosity and efficiency of any EL system, early systems were relatively highly efficient when compared to incandescent lamps and other high-loss illumination and/or CRT data display tubes that were standard in the 1960s. However, advances in materials science and manufacturing technologies increased the efficiency, durability, luminosity and life span of EL systems greatly during the 1980s. During this time, printed circuit board manufacturing, electroluminescent material chemistry, flexible thin films and various polymers all experienced significant levels of technical improvement allowing newer EL systems to be lighter, thinner, brighter and many times more efficient. These improvements led to the use of EL as the first cost effective, highly durable flat panel monitors that were subsequently implemented for aerospace, defense and early portable-computing applications. EL monitors worked in the same manner as any other EL lighting system, utilizing a backplane conductor, EL material and a transparent front conductor. However, these conductors were divided into sections defining a grid, or an addressable matrix so that individual pixels or light clusters could be illuminated to display complex graphics, video streams or other data, such as the output from a computer system.

Although EL video displays lost some popularity in response to the low-cost presence of LCD and Plasma display technologies, modern technological advances have permitted the use of electroluminescence as a source of low cost, flat-panel, flexible, super high efficiency illumination for many creative and non-traditional applications. Breakthroughs in automated manufacturing have lowered the costs of flexible PC boards and membrane circuits adding to the potential possibilities for technical creativity utilizing EL lighting panels, sometimes referred to as EL foils due to their thin properties. In addition, very low cost, high brightness electroluminescent printing has evolved as a result of the widespread use of large format inkjet printers and the presence of EL pigments that can be printed directly onto a multitude of surfaces to form an instant multicolor, multi-segment complex visual display designed specifically for any such predetermined tasks. This low cost, high volume method of custom EL display printing is the predominant driving force that has allowed for inexpensive high quality creative electroluminescent products to become part of mainstream technical industrial design culture and become the choice for high quality visually appealing displays and data interfaces.

As defined by a multitude of automotive related prior art, electroluminescent automotive gauges have reemerged as a popular styling tool for automotive industrial designers and for automotive customization enthusiasts whom both prefer the color and visual appeal of EL gauges over that of other dashboard illumination technologies. OEM suppliers of electroluminescent gauges such as Rodgers Corp. and Serigraph have partnered with vehicle manufacturers such as Daimler Chrysler to develop EL gauges that incorporate solid illumination segments as backlighting, in addition to switchable, addressable EL segments forming data display outputs for monitoring vehicle systems; all combined onto one low-cost membrane that is connected to a vehicle data module via a multi conductor cable to support real time information display.

In addition, an extensive aftermarket economy comprising many styles and brands of aftermarket retrofit electroluminescent flat panel custom gauges has emerged as a result of growing sport-compact and custom car trends in the U.S. Such trends grow from the collective efforts of custom car enthusiasts who utilize many low cost, visually appealing technologies to enhance the looks of various vehicle interior and exterior components and subsystems to create vehicles with appealing design. In addition to this popular automotive application for printed electroluminescent gauges, low cost flat panel illumination devices have also become commonplace in novelties, toys and promotional items. Illuminating hats, badges, safety stickers, drink ware, store signs and billboards have all emerged utilizing electroluminescent panels as back lights. Some items like sequential safety flashers, animated billboards and image changing billboards utilize switchable, sequenceable, segments of printed EL matter to form colorful animated attention-getting advertisements or visuals.

Electroluminescent lamps (EL) are composed of a layer of electrically activated phosphor glow-ink located in between two flexible, planar electrodes. Physically, electroluminescent lamps are flat, flexible and resemble a thin sheet of plastic. Durable and resilient, electroluminescent lamps can be curved, cut and molded into a variety of shapes. They can be punctured or pierced in numerous locations with no decrease in luminous performance. Electroluminescent lamps maintain their physical and electrical integrity throughout a broad temperature range and are not affected by moisture, vibration, mechanical shock and severe environmental conditions. Electroluminescent lamps are extremely energy efficient. They require higher voltages and frequencies for operation than conventional lamps. Most operate between 60 and 200 volts AC depending on the desired brightness of the illumination system. The current consumed by the EL lamp is proportional to the total surface area of the illuminating sections. The electrical requirements of EL lamps or systems are normally provided by a compact inverter the output of which is matched to the surface area, electrical characteristics and brightness levels of the EL system.

### DESCRIPTION OF THE PRIOR ART

Howell, U.S. Pat. No. 6,168,283, discloses an electroluminescent device for illuminating push button devices such as television remote controls, keypads for security systems, computer keyboards, beepers, night lights, telephones, portable emergency lighting, calculators and the like. The invention comprises a power supply which includes an electrical voltage inverter and a power source, and which is connected to a thin and flexible electroluminescent planar sheet containing embedded circuitry and powered by alternating current. The individual components are connected together by electrical leads. The thin electroluminescent lamp portion of the invention provides an even area of template illumination when it is placed over push buttons of an underlying device and that device can then be used under low-level illumination or even in complete darkness. Additionally, the electroluminescent device can be added during the manufacturing process or it can be retrofitted by the end-user to upgrade devices already in use. The planar sheet can be manufactured to glow in one or more of several colors, to suit the needs of the manufacturer or end-user.

Audio devices have also utilized electroluminescent lighting. Chien, U.S. Pat. No. 6,270,229, discloses the use of three dimensional electroluminescent lighting elements for speaker covers, headset housings, transparent telephone housings, computer speakers, televisions, compact disc players, synthesizers, and so forth for aesthetic purposes. The power source of the device is used to activate the electroluminescent elements rather than providing a separate power source. The intensity and colors of the lighting elements can be responsive to the frequency and/or volume of the audio signals.

Knoezer et al., U.S. Pat. No. 6,637,906, disclose an electroluminescent film used in the food packaging industry. A flexible electroluminescent film is sandwiched together with various polymer, ink and moisture-absorbing layers. A thin-film DC power source, a thin-film current inverter, and a thin-film touch sensitive switch are all incorporated within the layers of the packaging material. The electroluminescent material, various ink layers and opaque mask layers are arranged in such a manner as to illustrate a graphics image on the formed bag when the power system is activated.

Toffolo et al., U.S. Pat. No. 6,542,146, discloses a transparent display screen which can be positioned in a driver's line of sight or in front of mechanical indicators on an instrument panel. Since the display screen is transparent and does not include a frame around its perimeter, the display screen makes information available without obstructing the driver's view of the road. This is accomplished utilizing a transparent electroluminescent display. When the information is desired, a controller activates the electroluminescent display which displays, among other things, one of a plurality of gauges. These gauges indicate fuel level, vehicle speed, etc.

### SUMMARY OF THE INVENTION

The present invention provides an illumination source which can be placed on and attached to an enclosure, such as a component of an audio system in a vehicle; components of an audio or video system in the home; a CPU or computer housing; a computer game system housing, for example Play Station®, or Xbox®; signage. The illumination source comprises an electroluminescent lamp in the form of a panel or sheet which is constructed and arranged to fit onto most audio amplifiers for vehicles. They are also designed to fit onto and around other audio components. Other accessories, such as ornamental covers or grills, can be placed over top of the electroluminescent sheet. The ornamental covers, grills and electroluminescent sheets would be available in sizes which are compatible with most audio system components. A power supply is connected to the electroluminescent panel. The power supply, electroluminescent panel, grill and cover are constructed and arranged to allow for the rapid replacement of said electroluminescent sheets without the use of tools.

Accordingly, it is a primary objective of the instant invention to provide an electroluminescent panel which can be utilized with the components of a vehicle's audio system to enhance its aesthetic appeal.

It is a further objective of the instant invention to provide an electroluminescent panel which can be used in conjunction with various covers and grills for audio system components. The electroluminescent panel will normally be located in between the audio component and the grill or cover.

It is yet another objective of the instant invention to provide an electroluminescent panel which can be easily replaced by the average consumer without the use of tools when necessary. This overcomes the current problem of soldering the connections of the electroluminescent panel to the power supply.

It is a still further objective of the invention to provide electroluminescent panels of different colors which are interchangeable with each other.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an exploded perspective view of an amplifier, electroluminescent panel, grill and cover according to the invention.

FIG. 2 is an exploded perspective view of an alternate embodiment of the invention which includes an amplifier, electroluminescent panel, grill, filter, and cover.

FIG. 3 is an exploded perspective view of the electroluminescent panel and spring biased contacts on the amplifier.

FIG. 4 is an exploded side view of an alternative embodiment illustrating the cover being attached to the amplifier with clips or tracks.

FIG. 5 is an exploded side view of an alternative embodiment illustrating the cover attached to the amplifier with a hinge.

FIG. 6 is a perspective view of an alternative embodiment illustrating the cover attached to the amplifier with a hinge.

FIG. 7 is an exploded side view of an alternative embodiment illustrating the cover being attached to the amplifier with fasteners.

FIG. 8 is an exploded perspective view of an alternative embodiment including the amplifier, electroluminescent panel and cover.

FIG. 9 is an exploded perspective view of an alternative embodiment which includes an electroluminescent panel with portions removed.

FIG. 10 is a perspective view of a cover which incorporates audio output meters and LED power level meters.

FIG. 11 is a perspective view of a cover which incorporates cooling fans.

FIG. 12 is a perspective view of a module for holding a plurality of capacitors.

FIG. 13 is a perspective view of an amplifier incorporating multiple electroluminescent panels and covers.

FIG. 14 is a perspective view of a cylindrical capacitor with an electroluminescent panel surrounding it.

FIG. 15 is a perspective view of a mounting assembly for a cylindrical capacitor.

FIG. 16 is a partial end view of a cylindrical capacitor including one of the mounting brackets and spring biased electrical contacts.

FIG. 17 is a perspective view of signage incorporating electroluminescent panels.

FIG. 17A is an enlarged view of one of the EL panels in the sign.

FIG. 18 is a perspective view of a computer housing incorporating electroluminescent panels.

FIG. 19 is a perspective view of a computer game housing incorporating electroluminescent panels.

### DETAILED DESCRIPTION OF THE INVENTION

While the present invention is susceptible of embodiments in various forms, there is shown in the drawings and will hereinafter be described a presently preferred embodiment with the understanding that the present disclosure is to be considered an exemplification of the invention and is not intended to limit the invention to the specific embodiments illustrated.

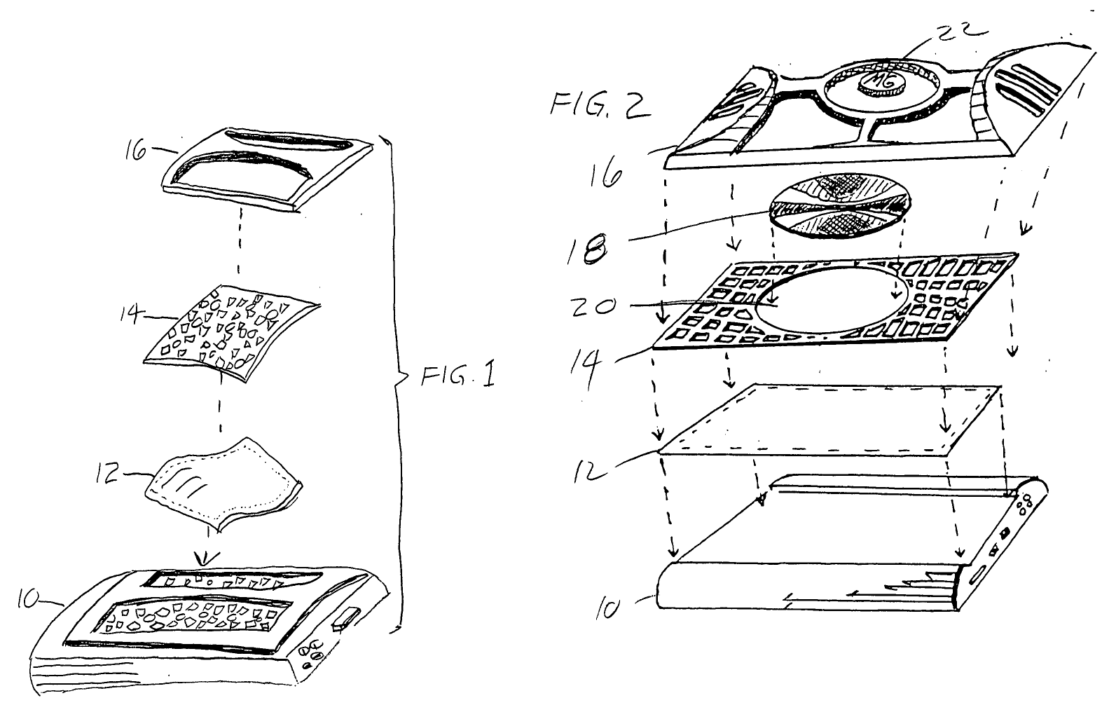

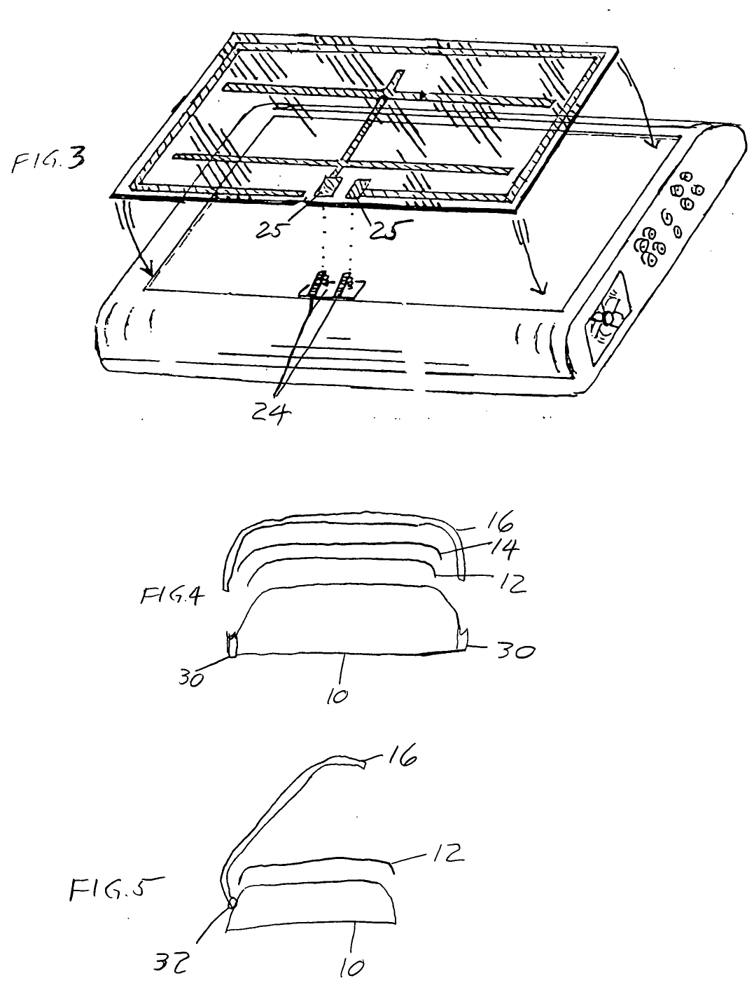

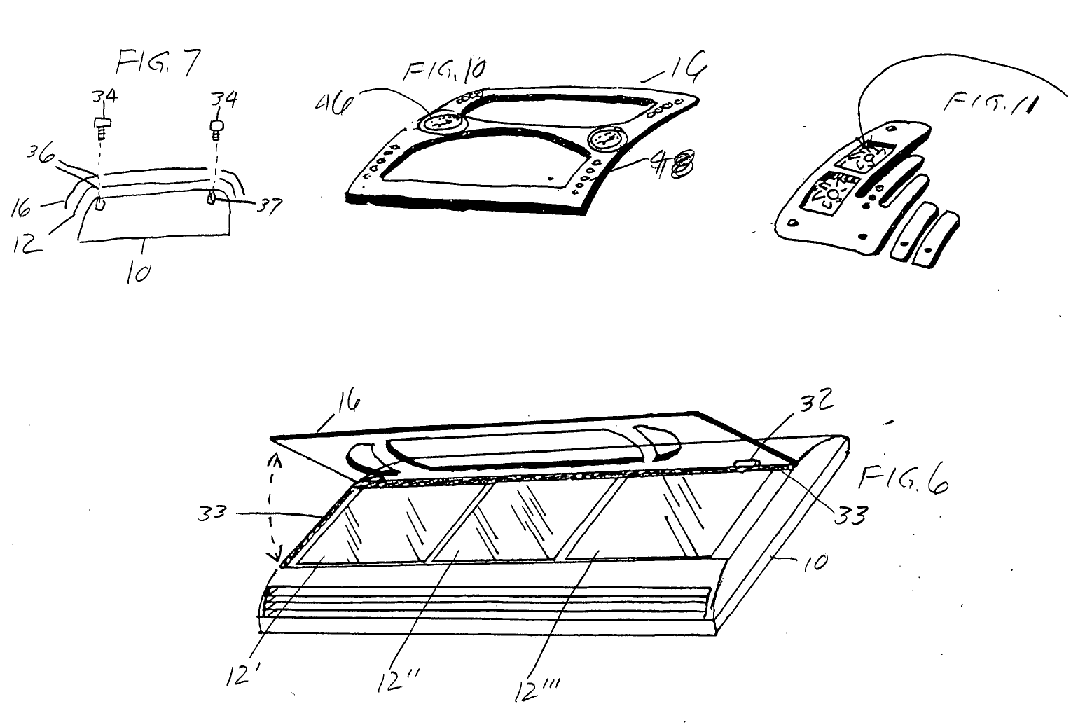

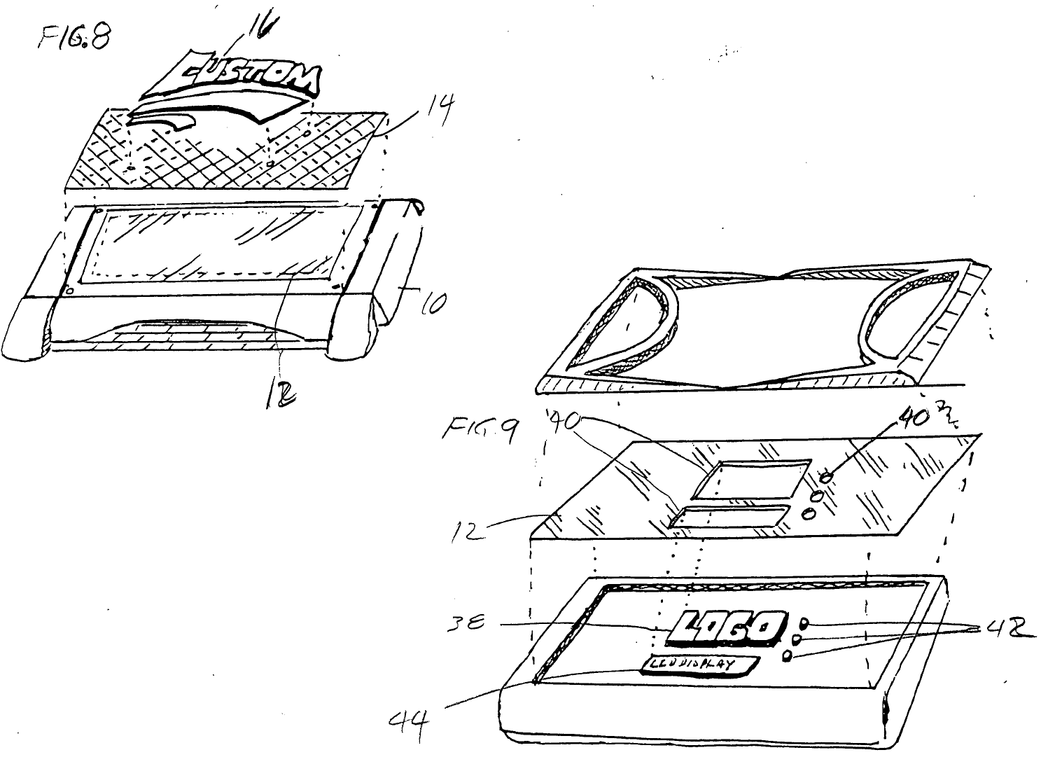

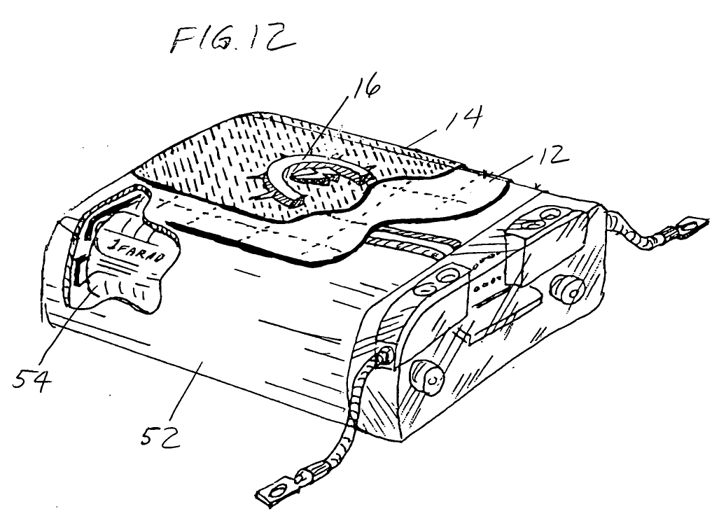

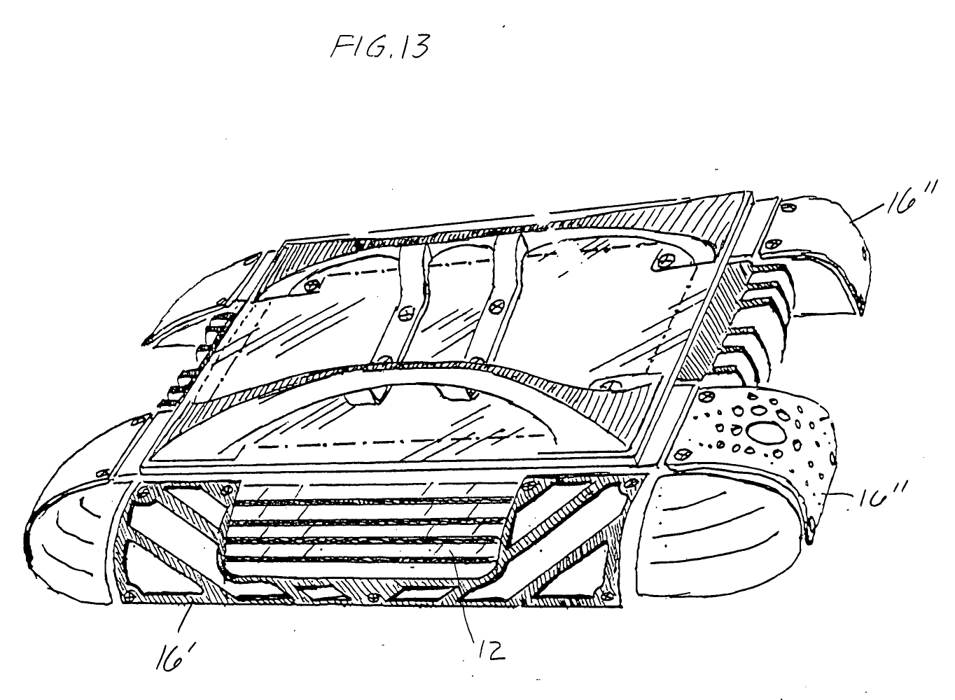

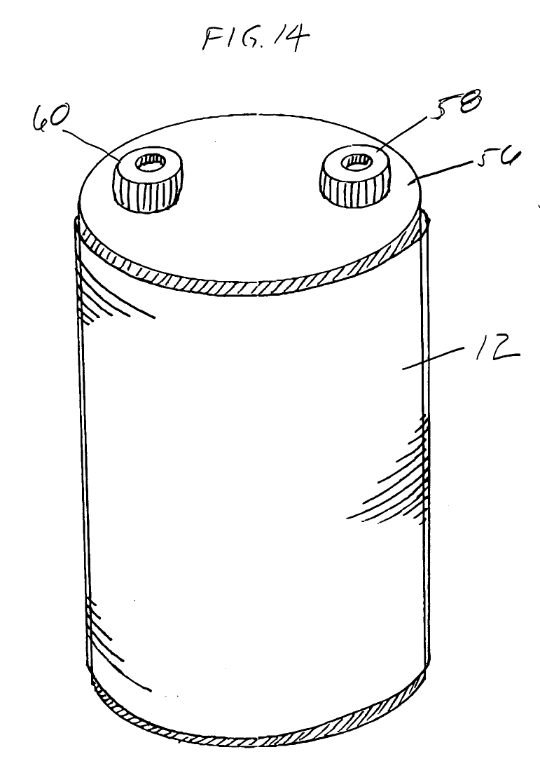

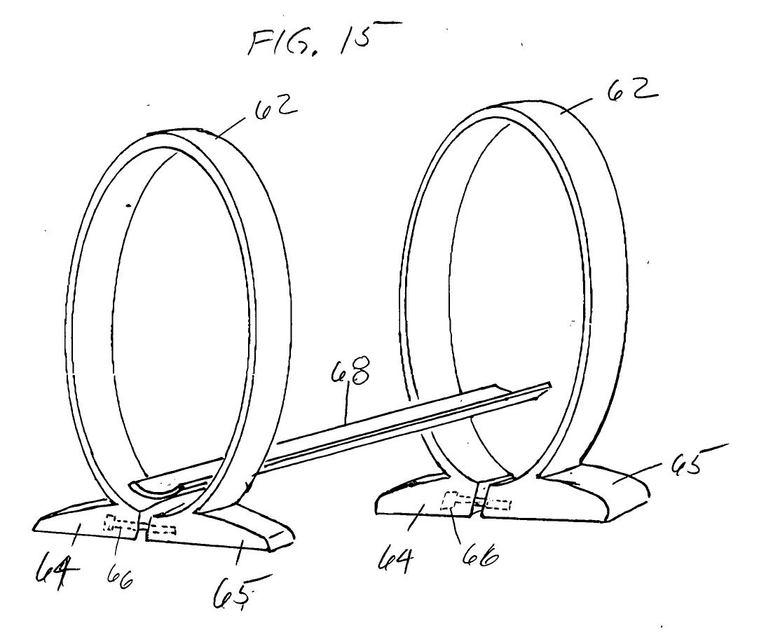

Referring to FIGS. 1-10, various embodiments of the instant invention are illustrated as being incorporated onto the components of audio systems. In general, an electroluminescent panel is designed to fit onto an amplifier or other component of an audio system. Mesh grills incorporating various designs are designed to fit over the electroluminescent panel. Ornamental covers are designed to fit over both the electroluminescent panel and mesh grill. Various gages, which indicate the parameters of the audio component, can be incorporated into the cover. It is important to note that the component description below is a general way to explain the system and its basic components. Given modern technology, many or all of the components could be combined or split in many ways and thus should not be limited to the specific component descriptions included herein.

In the embodiment illustrated in FIG. 1, an audio amplifier (or audio component) incorporating the electroluminescent panel, the mesh grill and the cover can be seen at 10. The order in which the elements can be placed on the amplifier is indicated by the dotted line and arrow. The electroluminescent panel 12 would be the first element to be placed onto the amplifier 10. Then the mesh grill 14 could optionally be placed over the electroluminescent panel. Finally the cover 16 could optionally be placed over the mesh grill. It is understood that if the mesh grill 14 was not utilized then the cover 16 would be placed over the electroluminescent panel 12. The electroluminescent panel, mesh grill, and cover are attached to the amplifier by various fasteners which will be illustrated in FIGS. 4-6.

In the embodiment illustrated in FIG. 2 the electroluminescent panel is designed to fit onto the amplifier or component 10. Next a mesh grill 14 is designed to be placed on top of the electroluminescent sheet 12. A color filter 18 may then be placed into a receiving area 20 located in the mesh grill 14. Translucent or transparent graphical overlays could be used in place of the color filters 18. Finally, a cover 16 is placed over the mesh grill 14 and color filter 18. Various indicia could be incorporated on the cover, as shown at 22. This could indicate the manufacturer of the amplifier or audio component; indicate a particular vehicle logo (Chevy, Harley Davidson, Honda, etc.) or any other design that the consumer would prefer.

A preferred type of electrical connection is illustrated in FIG. 3. Electrical contacts 24, on the amplifier, provide electrical power for the electroluminescent panel. These contacts mate with corresponding electrical conductor strips 26 and 28 positioned on the electroluminescent panel utilizing electrical contacts 25. The conductor strips provide the electrical power to activate the electroluminescent panel. The panel is shown as transparent for illustrative purposes only. A power inverter (not shown) is built into the amplifier or audio component. It converts the power normally used in vehicles, 12 volts direct current, into the power required to operate the electroluminescent panel, 60-150 volts alternating current.

Different fastening systems used to attach the electroluminescent panel, mesh grill and cover to the audio component are illustrated in FIGS. 4-7. In FIG. 4 the cover 16 fits into tracks or clips 30 mounted on the audio component. The electroluminescent panel 12 and mesh grill 14 are held in place by the cover 16. In FIG. 5 a hinge or plurality of hinges 32 are mounted on the amplifier and attached to the cover 16. In this embodiment the electroluminescent panel 12 is held in place when the cover is pivoted downwardly to mate with the audio component. In FIG. 6 hinges 32 (only one of which is shown) are mounted on the top portion of the amplifier and attached to the cover 16. The electroluminescent panel comprises three different panels 12′, 12″, 12′″ which could produce up to three different colors when activated. Foam, felt, cork sheets, etc. 33 may be attached to the underside of the cover or electroluminescent panel to reduce vibration and help hold the panel in position once the cover is closed. FIG. 7 utilizes fasteners which pass through apertures 36 in the cover 16 and electroluminescent panel 12 and are secured to the amplifier. In the embodiment shown, machine screws 34 are employed as the fasteners. The head of the machine screw is larger than the aperture 36 and the body of the machine screw is received in a threaded aperture 37 in the audio component. In place of the machine screws other fasteners such as studs and nuts, pins and clips, screws, etc. could be employed.

FIG. 8 illustrates another embodiment wherein the cover 16 comprises an ornament (the word Custom) which can be a word, phrase or logo. The ornament is attached to the mesh grill 14 by conventional means. The mesh grill in turn is attached to the audio component 10 by any of the previously disclosed fasteners.

FIG. 9 illustrates a further embodiment wherein a word, phrase or logo 38 is incorporated into the body of the audio component 10 in the form of a raised portion on the top thereof. The electroluminescent panel 12 and mesh grill, if employed, are provided with an aperture 40 through which the word or logo would project. Controls 42 for the audio component can also be incorporated into the top portion of the audio component. If desired a light emitting diode (LED) display 44 could also be incorporated into the top portion of the audio component. Additional apertures 40 would be provided to allow the controls 42 and LED display 44 to be accessible through the electroluminescent panel and mesh grill.

The embodiment disclosed in FIG. 10 is directed to a cover 16 which has audio output meters 46 and LED power level meters 48 built into it. These meters indicate the output of the audio component to which they are attached. The output indications are very helpful especially during the installation of the audio system. Optimal listening levels and correct balances are achieved utilizing this information. This is especially critical when the audio system is installed in a vehicle because of the location of the location of the speakers in relation to the listener.

FIG. 11 is directed to a further embodiment of a cover 16 wherein a fan or fans 50 are incorporated into the cover. These fans are used to provide cooling for the audio component. This is extremely helpful for components such as amplifiers which generate large amounts of heat. When these amplifiers are located in enclosed areas in vehicles there many not be sufficient natural air circulation to dissipate the heat produced during their operation. The provision of a fan or fans on the cover of the amplifier will properly dissipate the heat produced thereby assuring the proper operation and extending the life of the amplifier.

The embodiment shown in FIG. 12 includes a module which provides a housing 52 for multiple capacitors 54. An electroluminescent panel 12 is wrapped around the module. The ends of the panel will be positioned closely adjacent each other on the underside of the module. Conventional means are used to secure the ends of the panel to the module. A mesh grill 14 and/or cover 16 could be attached to the top portion of the module overlying the electroluminescent panel. When a module containing two conventional 1 Farad capacitors are used an electroluminescent panel of a conventional size will encompass the entire module.

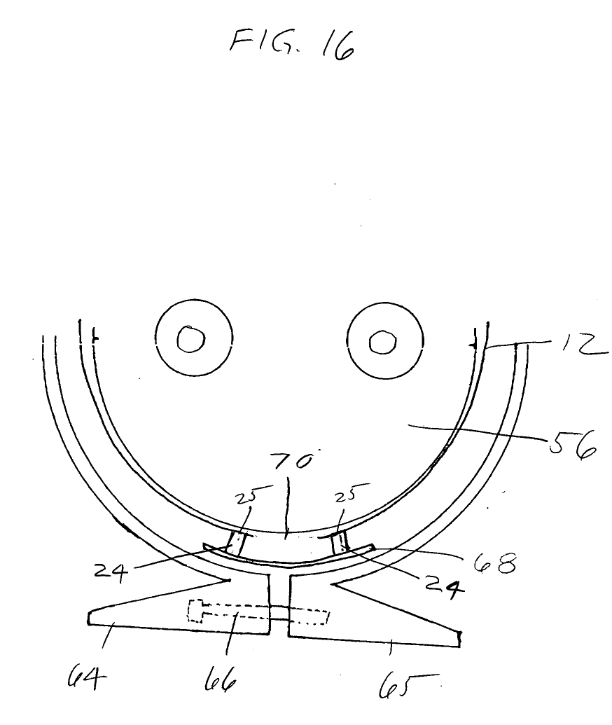

FIG. 13 discloses a further embodiment wherein electroluminescent panels and covers are located on different portions of the amplifier. Cover 16′ and underlying electroluminescent panel 12 are located on the front portion of the amplifier. The cover also serves as a heat sink to aid in cooling the amplifier. Additional decorative covers 16′ are provided on the corners of the amplifiers for aesthetic purposes. Underlying these covers are additional electroluminescent panels (not shown).

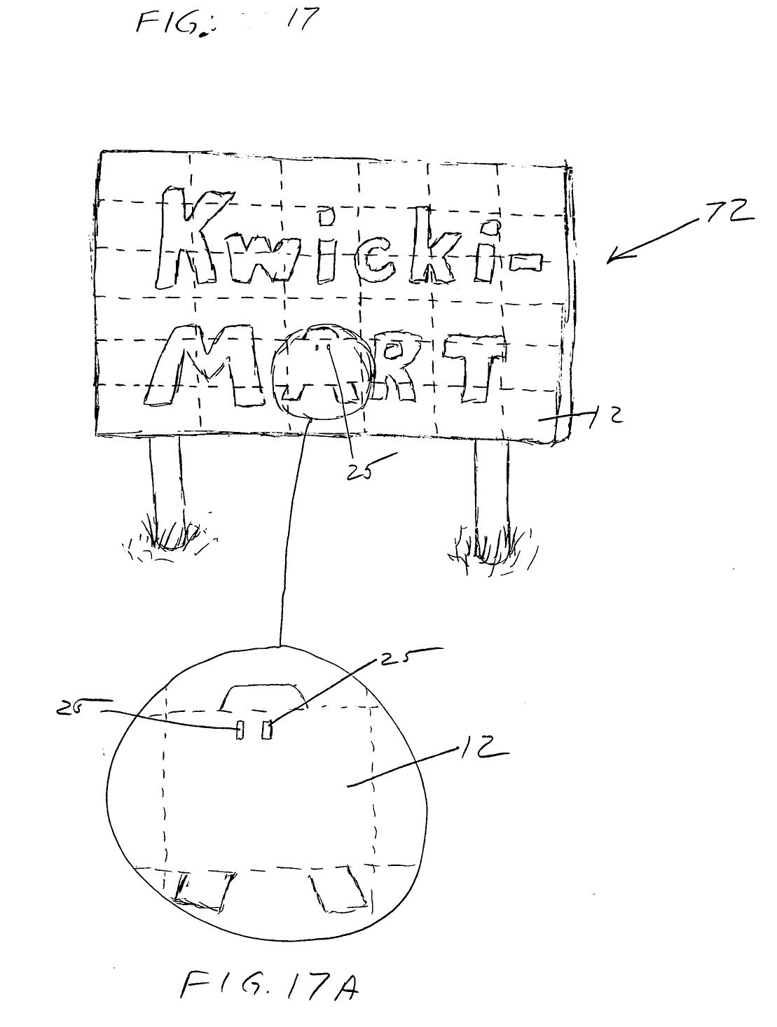

FIG. 14 discloses an additional embodiment wherein an electroluminescent panel is used with a cylindrical capacitor. The cylindrical capacitor is illustrated at 56. It includes terminals 58 and 60 for connection to an audio system. An electroluminescent panel 12 completely encircles the capacitor. The capacitor and panel are held in place by brackets 62 which are shown in FIG. 15. These brackets are substantially the same diameter as the capacitor. These brackets completely encircle the capacitor and panel to securely hold the panel onto the capacitor. The brackets are separated at the bottom which allows for them to be expanded to easily fit around the capacitor and electroluminescent panel. Flanges 64 and 65 are secured to each other by fasteners 66. When the fasteners are tightened, the flanges are drawn toward each other which decreases the diameter of the bracket. This results in a proper and tight fit around the capacitor and panel ensuring that the panel will not separate from the capacitor. An elongate strip 68 could also be employed to provide additional support for the electroluminescent panel where the ends of the panel abut each other. Flanges 64 and 65 could also be provided with means to attach them to a mounting surface to provide a convenient means to locate the capacitor wherever it was required.

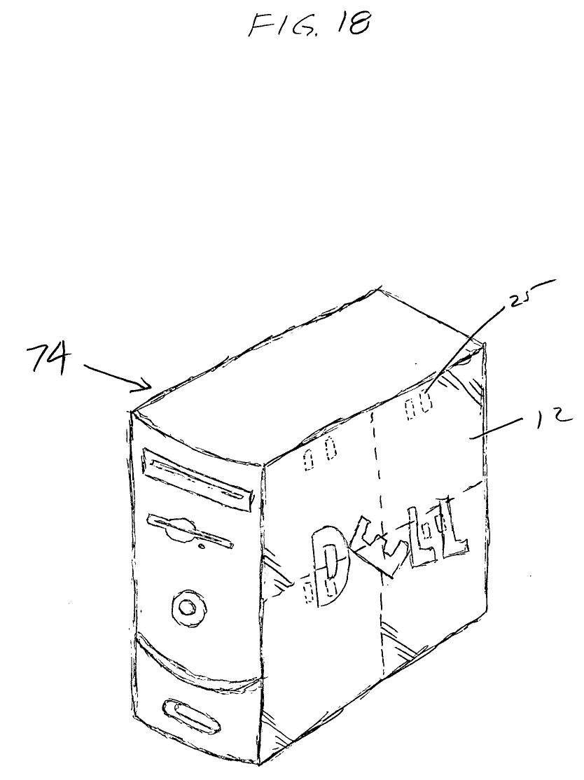

FIG. 16 illustrates a partial end view of the manner in which the elongate strip 68 functions to hold the end portions of the electroluminescent panel in abutting relationship. Prior to the brackets 62 being tightened the end portions of the panel are separated, as shown at 70. Tightening the fasteners 66 draws the flanges together reducing the diameter of the bracket and drawing the end portions of the panel toward each other. Clip 68 holds the end portions in abutting relationship in between the brackets 62. In addition, elongate clip is provided with flexible, resilient electrical contacts 24 which will engage electrical contacts 25 on the electroluminescent panel.

FIG. 17 illustrates signage 72 in which a plurality of electroluminescent panels 12 are arranged to form a word, words or pictures for a sign. The electroluminescent panels receive their power through electrical contacts 25 provided on each electroluminescent panel. These contacts cooperate with additional contacts (not shown) which are similar to contacts 24 in FIG. 3 to receive power to activate the electroluminescent panels.

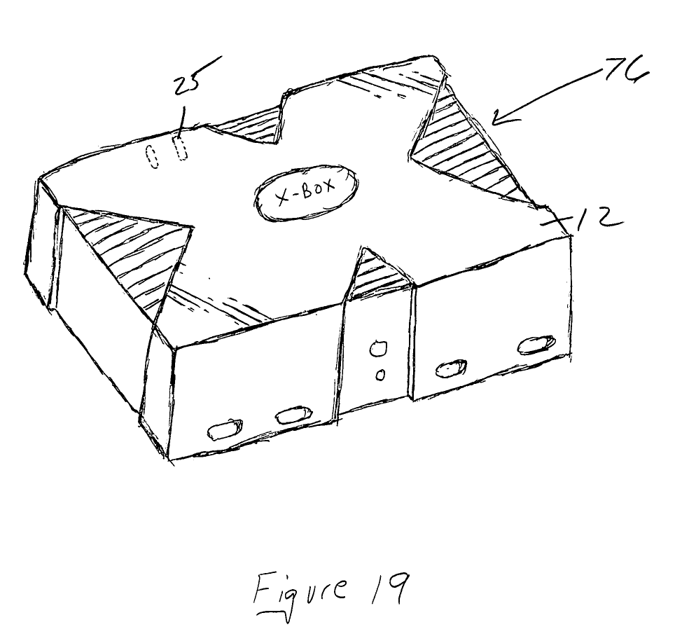

FIG. 18 illustrates a housing 74 for a computer which is provided with a plurality of electroluminescent panels 12 on a side portion. The electroluminescent panels are provided with electrical contacts 25 to receive power for activating the electroluminescent panels in a manner similar to that disclosed in FIG. 17.

FIG. 19 illustrates a housing 76 for a computer game which is provided with one or more electroluminescent panels 12 attached thereto. The electroluminescent panels are provided with electrical contacts 25 to receive power for activating the electroluminescent panels in a manner similar to that disclosed in FIG. 17.

In addition to employing electroluminescent panels in the form of lamps for the signage and computer housings, panels can be formed from screen printing with special inks. An example of this is the DuPont Luxprint® EL system. The special inks are provided by the DuPont company while the other materials such as the transparent sputtered ITO (Indium Tin Oxide) polyester substrate, and the power supply must be obtained from other sources. In addition the panels could be formed utilizing inkjet printers and special inks. This would result in limitless possibilities for designs and signage.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An electroluminescently illuminated enclosure comprising:
a structure adapted for containment therein of at least one device;
said structure constructed and arranged to receive at least one electroluminescent member, said electroluminescent member constructed and arranged for mechanical engagement with said structure;
said structure including at least one first electrical conducting means;
said electroluminescent member containing at least one second electrical conducting means;
said first and second electrical conducting means being constructed and arranged to enable electrical communication between each said electroluminescent member and said structure concomitant with mechanical engagement of said electroluminescent member and said structure;
whereby electrical power is communicated from said first electrical conducting to said second electrical conducting means for illumination of said electroluminescent member.

2. The electroluminescently illuminated enclosure of claim 1 wherein a cover is positioned over said electroluminescent member in juxtaposition thereto.

3. The electroluminescently illuminated enclosure of claim 1 wherein a mesh grill is positioned over said electroluminescent member in juxtaposition thereto.

4. The electroluminescently illuminated enclosure of claim 3 wherein a cover is positioned over said mesh grill in juxtaposition thereto.

5. The electroluminescently illuminated enclosure of claim 2 wherein said cover extends over only a portion of said electroluminescent member.

6. The electroluminescently illuminated enclosure of claim 2 wherein said cover extends entirely over said electroluminescent member.

7. The electroluminescently illuminated enclosure of claim 3 wherein said mesh grill extends over only a portion of said electroluminescent member.

8. The electroluminescently illuminated enclosure of claim 3 wherein said mesh grill extends entirely over said electroluminescent panel.

9. The electroluminescently illuminated enclosure of claim 4 wherein said cover extends over only a portion of said mesh grill.

10. The electroluminescently illuminated enclosure of claim 4 wherein said cover extends entirely over said mesh grill.

11. The electroluminescently illuminated enclosure of claim 1 wherein said first electrical conducting means comprises resilient contact elements positionable on said structure;
said resilient contact elements connected to a power supply;
said second electrical conducting means comprising contact elements fixedly attached to said electroluminescent member.

12. The electroluminescently illuminated enclosure of claim 1 including means to hold said electroluminescent member in juxtaposition to said structure.

13. The electroluminescently illuminated enclosure of claim 12 wherein the means to hold said electroluminescent member comprises a cover.

14. The electroluminescently illuminated enclosure of claim 13 wherein said cover extends over only a portion of said electroluminescent member.

15. The electroluminescently illuminated enclosure of claim 13 wherein said cover extends entirely over said electroluminescent member.

16. The electroluminescently illuminated enclosure of claim 1 including multiple electroluminescent members positioned in the same plane in juxtaposition to said structure.

17. The electroluminescently illuminated enclosure of claim 16 wherein said multiple electroluminescent members comprise panels which produce different colors upon activation.

18. The electroluminescently illuminated enclosure of claim 16 wherein a cover is positioned over said electroluminescent members in juxtaposition thereto.

19. The electroluminescently illuminated enclosure of claim 17 wherein a cover is positioned over said electroluminescent members in juxtaposition thereto.

20. The electroluminescently illuminated enclosure of claim 12 wherein the means to hold the electroluminescent panel comprise fasteners.

21. The electroluminescently illuminated enclosure of claim 2 wherein said cover is hingably connected to said structure.

22. The electroluminescently illuminated enclosure of claim 4 wherein said cover is hingably connected to said structure.

23. The electroluminescently illuminated enclosure of claim 5 wherein said cover is hingably connected to said structure.

24. The electroluminescently illuminated enclosure of claim 6 wherein said cover is hingably connected to said structure.

25. The electroluminescently illuminated enclosure of claim 9 wherein said cover is hingably connected to said structure.

26. The electroluminescently illuminated enclosure of claim 10 wherein said cover is hingably connected to said structure.

27. The electroluminescently illuminated enclosure of claim 13 wherein said cover is hingably connected to said structure.

28. The electroluminescently illuminated enclosure of claim 15 wherein said cover is hingably connected to said structure.

29. The electroluminescently illuminated enclosure of claim 16 wherein said cover is hingably connected to said structure.

30. The electroluminescently illuminated enclosure of claim 18 wherein said cover is hingably connected to said structure.

31. The electroluminescently illuminated enclosure of claim 19 wherein said cover is hingably connected to said structure.

32. The electroluminescently illuminated enclosure of claim 1 wherein said structure is cylindrical.

33. The electroluminescently illuminated enclosure of claim 32 including means to hold said electroluminescent member in juxtaposition to said structure.

34. The electroluminescently illuminated enclosure of claim 33 wherein the means to hold said electroluminescent member are brackets which encircle said electroluminescent member and said structure.

35. The electroluminescently illuminated enclosure of claim 34 including means to expand said brackets to allow said electroluminescent member and said structure to be placed into said brackets and means to tighten and contract said brackets to securely attach said brackets to said electroluminescent member and said structure.

36. The electroluminescently illuminated enclosure of claim 34 wherein the means to hold said electroluminescent member further includes an elongate strip extending along substantially the length of said structure and in between said brackets, the width of said elongate strip is sufficient to guide the ends of said electroluminescent member into an abutting relationship upon activation of the means to tighten said brackets.

37. The electroluminescently illuminated enclosure of claim 36 wherein said first electrical conducting means comprises resilient contact elements positionable on said elongate strip;
said resilient contact elements connected to a power supply;
said second electrical conducting means comprising contact elements fixedly attached to said electroluminescent member.

38. The electroluminescently illuminated enclosure of claim 32 wherein said structure is a capacitor for use in an audio system.

39. The electroluminescently illuminated enclosure of claim 38 wherein said structure is a housing for multiple capacitors.

40. The electroluminescently illuminated enclosure of claim 1 wherein said structure is an amplifier for an audio system.

41. The electroluminescently illuminated enclosure of claim 1 wherein said structure is a component of a home audio system.

42. The electroluminescently illuminated enclosure of claim 1 wherein said structure is a component of a home video system.

43. The electroluminescently illuminated enclosure of claim 1 wherein said structure is a component of an audio system in a vehicle.

44. The electroluminescently illuminated enclosure of claim 1 wherein said structure is a housing for a computer.

45. The electroluminescently illuminated enclosure of claim 1 wherein said structure is a housing for a computer game.

46. The electroluminescently illuminated enclosure of claim 1 wherein said structure is signage.
